(19) United States
(12) Patent Application Publication
(10) Pub. No.: US 2023/0342371 A1
(43) Pub. Date: Oct. 26, 2023

(54) TIME-SERIES DATA ANALYSIS DEVICE, TIME-SERIES DATA ANALYSIS METHOD, AND NON-TRANSITORY COMPUTER READABLE MEDIUM STORING TIME-SERIES DATA ANALYSIS PROGRAM

(71) Applicant: Mitsubishi Electric Corporation, Tokyo (JP)

(72) Inventor: Takaaki NAKAMURA, Tokyo (JP)

(73) Assignee: Mitsubishi Electric Corporation, Tokyo (JP)

(21) Appl. No.: 18/216,107

(22) Filed: Jun. 29, 2023

Related U.S. Application Data
(63) Continuation of application No. PCT/JP2021/006025, filed on Feb. 18, 2021.

(51) Int. Cl. G06F 16/2458

(52) U.S. Cl. CPC G06F 16/2477

(57) ABSTRACT

A time-series data analysis device, includes: a time-series data input unit to receive time-series data; a parameter setting unit to set a range of a window length of a time series subsequence in the time-series data; a feature calculating unit to calculate a feature of the time-series data for each of a plurality of window lengths within the range; a probability density distribution calculating unit to calculate a probability density distribution of the calculated feature for each of the plurality of window lengths; and a parameter selecting unit to calculate a statistical feature of the probability density distribution calculated for each of the plurality of window lengths and select a window length to be used from among the plurality of window lengths on the basis of the calculated statistical feature.

### CROSS REFERENCE TO RELATED APPLICATIONS

This application is a Continuation of PCT International Application No. PCT/JP2021/006025 filed on Feb. 18, 2021, which is hereby expressly incorporated by reference into the present application.

### TECHNICAL FIELD

The present disclosure relates to a time-series data analysis device, a time-series data analysis method, and a non-transitory computer readable medium storing time-series data analysis program for extracting a feature from time-series data.

### BACKGROUND ART

When the time-series data is analyzed and the feature of the time-series data is extracted, a slide window is used. In order to use the slide window, the length of the slide window (Hereinafter, the length may be referred to as a “window length”.) is specified. For example, Non-Patent Literature 1 discloses a technique of generating a distance matrix in which a distance between time series subsequences having a length m in time-series data is obtained using a slide window having a length m, and extracting a feature called a matrix profile from the distance matrix.

### CITATION LIST

### Non-Patent Literature

Non-Patent Literature 1: Yeh, Chin-Chia Michael, et al. “Matrix profile I:all pairs similarity joins for time series: a unifying view that includes motifs, discords and shapelets.” 2016 IEEE 16th international conference on data mining (ICDM). IEEE, 2016.

### SUMMARY OF INVENTION

### Technical Problem

However, in conventional techniques using a slide window including the technique of Non-Patent Literature 1, since the window length is determined by a person who analyzes time-series data, there is a problem that a significant feature cannot be extracted in some cases.

The present disclosure has been made in order to solve the above problem, and an object according to an aspect of the embodiments is to provide a time-series data analysis device capable of proposing a window length of a slide window used when time-series data is analyzed.

### Solution to Problem

A time-series data analysis device according to the present disclosure includes: processing circuitry to receive time-series data; to set a range of a window length of a time series subsequence in the time-series data; to calculate a feature of the time-series data for each of a plurality of window lengths within the range; to calculate a probability density distribution of the calculated feature for each of the plurality of window lengths: and to calculate a statistical feature of the probability density distribution calculated for each of the plurality of window lengths and select a window length to be used from among the plurality of window lengths on the basis of the calculated statistical feature.

### Advantageous Effects of Invention

According to an aspect of the time-series data analysis device of the present disclosure, it is possible to propose a window length used when a feature is extracted from time-series data.

### BRIEF DESCRIPTION OF DRAWINGS

FIG. 1 is a diagram illustrating a configuration example of a time-series data analysis device according to a first embodiment.

FIG. 2 is a diagram illustrating a modification of the configuration of the time-series data analysis device.

FIG. 3A is a diagram illustrating an example of time-series data.

FIG. 3B is a diagram illustrating a pan-matrix profile.

FIG. 3C is a heat map of a probability density distribution of a matrix profile.

FIG. 4 illustrates a selection algorithm of a subsequence length.

FIG. 5A is a diagram illustrating a configuration example of hardware of a time-series data analysis device.

FIG. 5B is a diagram illustrating another configuration example of hardware of the time-series data analysis device.

FIG. 6 is a flowchart of a time-series data analysis method.

FIG. 7A is a diagram illustrating an example of time-series data.

FIG. 7B is a diagram illustrating a pan-matrix profile.

FIG. 7C is a heat map of a probability density distribution of a matrix profile.

FIG. 8 is a diagram illustrating a configuration example of a time-series data analysis device according to a second embodiment.

FIG. 9A is a diagram illustrating an example of time-series data.

FIG. 9B is a diagram illustrating double amplitude values.

FIG. 9C is a heat map of a probability density distribution of double amplitude values.

### DESCRIPTION OF EMBODIMENTS

### First Embodiment

### < Configuration >

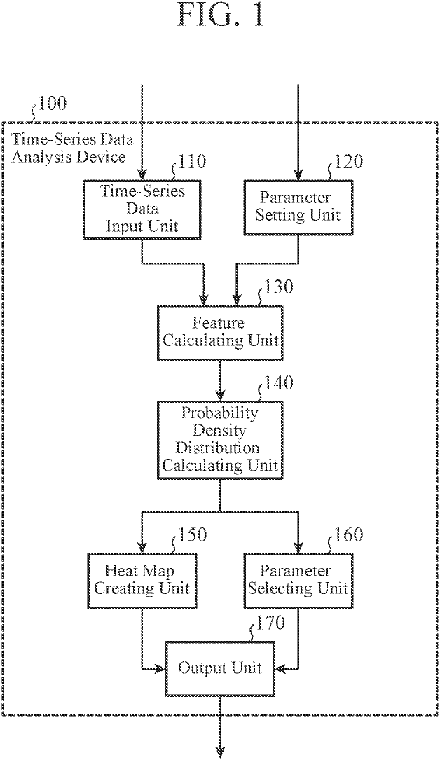

Hereinafter, various embodiments according to the present disclosure will be described in detail with reference to the drawings. FIG. 1 is a diagram illustrating a configuration example of a time-series data analysis device 100 according to a first embodiment. The time-series data analysis device 100 includes a time-series data input unit 110, a parameter setting unit 120. a feature calculating unit 130, a probability density distribution calculating unit 140, a heat map creating unit 150. a parameter selecting unit 160, and an output unit 170.

### (Time-Series Data Input Unit)

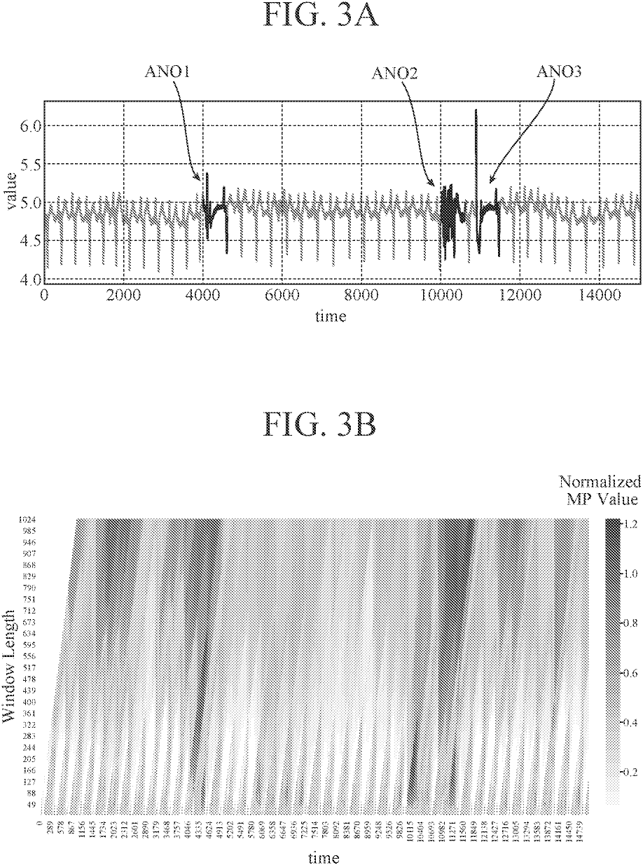

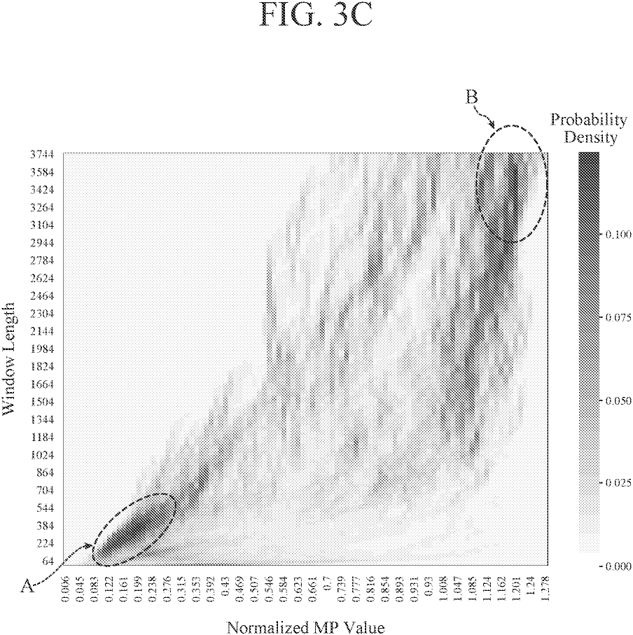

The time-series data input unit 110 receives time-series data. Examples of the time-series data include, but are not limited to, industrial data such as voltage, current, frequency, or motor rotational speed acquired from a monitored device, medical data such as pulse rate, respiratory rate, or blood pressure, economic data such as stock price, future transaction price, or gross domestic product, and social activity data such as the number of passengers of public transportation such as trains, buses, or airplanes. As an example, the time-series data input unit 110 receives the time-series data as illustrated in FIG. 3A (Source of data: E.Keogh, J.Lin and A.Fu (2005).HOT SAX: Efficiently Finding the Most Unusual Time Series Subsequence. In The Fifth IEEE International Conference on Data Mining.: Internet < URL: http://www.cs.ucr.edw/~eamonn/discords/ >). FIG. 3A is electrocardiogram data in which anomaly is known. The electrocardiogram data includes ANO1, ANO2, and ANO3 as anomaly points. The time-series data input unit 110 supplies the received time-series data to the feature calculating unit 130.

### (Parameter Setting Unit)

The parameter setting unit 120 receives a parameter value input by a user and used for analysis. The parameter may include an upper limit value and a lower limit value that define the range of the window length of the time series subsequence in the time-series data, and a value that specifies the type of normalization method when calculating the Euclidean distance between the time series subsequences from the time-series data.

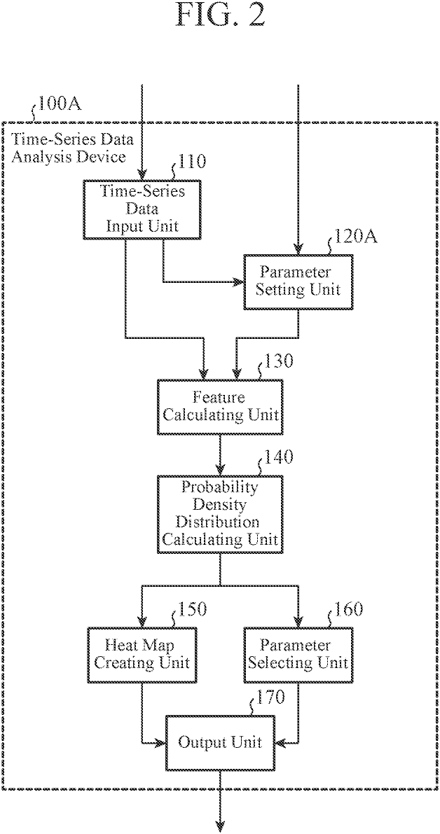

The window length range may be set by the time-series data analysis device 100 instead of the user input. For example, as in a time-series data analysis device 100A illustrated in FIG. 2, a parameter setting unit 120A may be provided at a subsequent stage of the time-series data input unit 110, and the parameter setting unit 120A may determine a range such as 10 (lower limit value) to 1/n (upper limit value) of the length of the time-series data. The character n is any positive integer. Alternatively, the parameter setting unit 120A may determine the range such as 1/n (lower limit value) of the length of the time-series data to 1000 (upper limit value). Alternatively, the parameter setting unit 120A may determine the range such as 1/10n (lower limit value) to 1/n (upper limit value) of the length of the time-series data. Like the parameter setting unit 120, the parameter setting unit 120A receives a value that specifies the type of the normalization method.

As the normalization method, for example, there are no normalization which performs no normalization, an average zeroing in which an average value of a time series subsequence is subtracted from each value of a time series subsequence for each time series subsequence, z normalization in which an average value is subtracted from each value of a time series subsequence for each time series subsequence and divided by a standard deviation, and a method using a correlation coefficient.

The parameter setting unit 120 or the parameter setting unit 120A supplies the value of the received or determined parameter to the feature calculating unit 130.

### (Feature Calculating Unit)

The feature calculating unit 130 calculates the feature of the time-series data on the basis of the time-series data supplied from the time-series data input unit 110 and the parameter value supplied from the parameter setting unit 120. In the first embodiment, a matrix profile is calculated as the feature. Specifically, the matrix profile is calculated as follows.

First, the feature calculating unit 130 sets a time series subsequence defined by a window having a window length m from the head of the time-series data as a reference. Note that the window length m is a length within a range defined by the above-described lower limit value and upper limit value. Next, the feature calculating unit 130 slides the window in the time-series data from the head of the time-series data one time step at a time to calculate a pairwise Euclidean distance between the reference and a time series subsequence at each time step, and to generate a first distance vector having the pairwise Euclidean distances as elements. The Euclidean distances are calculated according to a specified normalization method.

Next, the feature calculating unit 130 shifts the window to the second position from the head of the time-series data by one time step without changing the window length m, and sets the time series subsequence defined by the shifted window as a new reference. The feature calculating unit 130 slides the window in the time-series data from the head of the time-series data one time step at a time to calculate a pairwise Euclidean distance between the new reference and a time series subsequence at each time step, and to generate a second distance vector having the pairwise Euclidean distances as elements.

Next, the feature calculating unit 130 further shifts the window to the third position from the head of the time-series data by one time step without changing the window length m, and repeats the same processing. In this way, while the time series subsequence used as the reference is changed, a pairwise distance profile is generated between the reference having the window length m and each time series subsequence defined by the window length having the same size, and a plurality of distance vectors having pairwise Euclidean distances as elements are generated.

The feature calculating unit 130 generates a distance matrix by vertically arranging the plurality of generated distance vectors. Specifically, the feature calculating unit 130 extracts the minimum distance for each row from the generated distance matrix in which the diagonal components and their peripheral components are excluded. From the first row of the distance matrix, the minimum distance in a case where the reference is the head position of the time-series data is extracted. From the second row of the distance matrix, the minimum distance in a case where the reference is at the second position from the head of the time-series data is extracted. From the third row of the distance matrix, the minimum distance in a case where the reference is the third position from the head of the time-series data is extracted. In general, from the n-th row of the distance matrix, the minimum distance in a case where the reference is at the n-th position from the head of the time-series data is extracted. Note that n is a positive integer. As a result, the minimum distance at each position of the reference, that is, at each time is extracted. In this way, a profile of the distance matrix in a case of the window length m is generated. That is, a matrix profile is generated. Note that the diagonal component in the distance matrix is a distance between each reference and itself, and is a trivial match that is always zero. In addition, the peripheral component of the diagonal component may also be zero. Since such a diagonal component and its peripheral component do not have significant information, the minimum distance is extracted from the distance matrix in which the diagonal components and their peripheral components are excluded. Note that “peripheral” is, for example, a range from a before-after window length of the diagonal component to a window length/k (about k ≤ 4), but is not limited to this specific example.

Note that a distance matrix may be generated by transposing the plurality of generated distance vectors as vertical vectors and arranging the vectors horizontally, and the minimum distance may be extracted from each row in the generated distance matrix.

A time series subsequence having a particularly small value in the generated matrix profile means that there are other time series subsequences similar to this time series subsequence. That is, it is suggested that some pattern is stored in the time-series data. Conversely, a time series subsequence having a particularly large value in the matrix profile means an outlier, and the presence of such a time series subsequence suggests that an anomaly is included in the time-series data.

The feature calculating unit 130 changes the value of the length m of the time series subsequence within the range of the upper limit value and the lower limit value of the length of the time series subsequence set via the parameter setting unit 120, and generates a matrix profile for each of various types of m. The matrix profile may be generated for all values within that range, or may be generated for discrete values. Such an aggregate of two or more matrix profiles, including matrix profiles generated for all values of m, as well as matrix profiles generated for discrete values of m, may be referred to herein as a pan-matrix profile (PMP). Furthermore, in a case where there are a plurality of specified normalization methods, the feature calculating unit 130 generates PMPs for all the methods.

FIG. 3B is a pan-matrix profile PMP generated from the time-series data of FIG. 3A. That is, FIG. 3B is a matrix profile generated for various values of m from the time-series data of FIG. 3A while changing the window length m. In FIG. 3B, darker portions indicate larger values of the matrix profile. Since the Euclidean distance and thus the value of the matrix profile increases as the window length increases, the value of the matrix profile is normalized by dividing the value of the matrix profile by the square root of the window length.

The feature calculating unit 130 supplies the generated pan-matrix profile PMP to the probability density distribution calculating unit 140 as a feature of time-series data. The processing result of the feature calculating unit 130 may be temporarily stored in a storage (not illustrated), and a functional unit at a subsequent stage may perform predetermined processing with reference to the storage as necessary. The storage may be provided in the time-series data analysis device 100 or may be provided outside the time-series data analysis device 100. The same applies to the processing results of the probability density distribution calculating unit 140, the heat map creating unit 150, and the parameter selecting unit 160.

As described above, the feature calculating unit 130 calculates a matrix profile, which is a feature of time-series data, for each of the plurality of window lengths within the range set by the parameter selecting unit 120.

### (Probability Density Distribution Calculating Unit)

The probability density distribution calculating unit 140 calculates a probability density distribution PDD from the feature supplied from the feature calculating unit 130. Specifically, the probability density distribution calculating unit 140 calculates the probability density distribution PDD of the pan-matrix profile PMP using the value of the normalized matrix profile as a random variable for each window length of the pan-matrix profile PMP supplied from the feature calculating unit 130.

The small value of the matrix profile means that the degree of similarity between the reference time series subsequence and the comparison target time series subsequence is high. Conversely, the large value of the matrix profile means that the degree of dissimilarity between the reference time series subsequence and the comparison target time series subsequence is high.

Therefore, in the case of time-series data including random signals and rare regular signals, when a window length is appropriately set from the time-series data and a matrix profile is created to create a probability density distribution, a peak of the distribution in the probability density distribution is on the right side. That is, the skewness becomes negative, and the peak of the distribution in the probability density distribution appears in a region where the value of the matrix profile is large. The appropriate window length mentioned here is a time width of the regular signal.

In addition, in the case of time-series data including a regular signal and an irregular or sudden anomaly that occurs rarely, when a window length is appropriately set from the time-series data and a matrix profile is created to create a probability density distribution, a peak of the distribution in the probability density distribution is on the left side. That is, the skewness is positive, and the peak of the distribution in the probability density distribution appears in the region where the value of the matrix profile is small. Examples of time-series data including irregularity or sudden anomaly include, for example, electrocardiogram data acquired from a person with arrhythmia.

The probability density distribution calculating unit 140 supplies the probability density distribution PDD calculated for each m to the heat map creating unit 150 and the parameter selecting unit 160.

### (Heat Map Creating Unit)

The heat map creating unit 150 creates a heat map from the probability density distribution PDD for each m supplied from the probability density distribution calculating unit 140. Here, an example of the heat map created by the heat map creating unit 150 will be described with reference to FIG. 3C. FIG. 3C is a heat map created from the pan-matrix profile PMP of FIG. 3B, and points of interest are indicated by circles A and B. In FIG. 3C, the vertical axis represents the length of the window length, and the horizontal axis represents the normalized matrix profile value. Note that, although only the case where the window length is 1024 is displayed in FIG. 3B, in a case where the heat map having the window length of up to 3744 is created as illustrated in FIG. 3C, the pan-matrix profile PMP having the window length of up to 3744 is generated, and the heat map as illustrated in FIG. 3C is created from such a pan-matrix profile PMP.

In the heat map of FIG. 3C, a region indicated by a circle A indicates a region where, when the window length is 384 and its neighbors, the values of the matrix profile are concentrated at relatively small 0.199 and its neighbors. As described above, the fact that the distribution having a high probability density is obtained in the region where the value of the matrix profile is relatively small means that the probability density is small in the region where the values of the matrix profile are relatively large. Therefore, if a peak can be extracted from the region of the circle A. an appropriate window length when finding discord can be obtained. Here, the term “discord” refers to an area in which the values of the matrix profile are relatively large in the matrix profile, and suggests the presence of anomaly in the time-series data. It is conceivable to extract a portion having a high appearance frequency in the region of the circle A, for example, using an index such as a portion having a large maximum value (maximum), a portion having a small standard deviation (minimum), a portion having a large skewness (positive skewness), or a portion having a large kurtosis (maximum). Only one index may be used, or a plurality of indexes may be used.

In the heat map of FIG. 3C. a region indicated by a circle B indicates a region where, when the window length is 3584 and its neighbors, the values of the matrix profile are concentrated at relatively large 1.162 and its neighbors. As described above, the fact that the distribution having a high probability density is obtained in the region where the values of the matrix profile are relatively large means that the probability density is small in the region where the values of the matrix profile are relatively small. Therefore, if a peak can be extracted from the region of the circle B, an appropriate window length when finding motif can be obtained. Here, the term “motif” refers to an area in which the values of the matrix profile are relatively small in the matrix profile, and suggests the presence of a pattern that repeatedly appears in the time-series data. It is conceivable to extract a portion having a high appearance frequency in the region of the circle B, for example, using an index such as a portion having a large maximum value (maximum), a portion having a small standard deviation (minimum), a portion having a small skewness (negative skewness), or a portion having a large kurtosis (maximum). Only one index may be used, or a plurality of indexes may be used.

The peak in the circle A or the circle B and the window length related to the peak may be determined by the user with reference to the heat map or may be extracted by processing of the parameter selecting unit 160 described later. The heat map creating unit 150 outputs the created heat map to the output unit 170.

### (Parameter Selecting Unit)

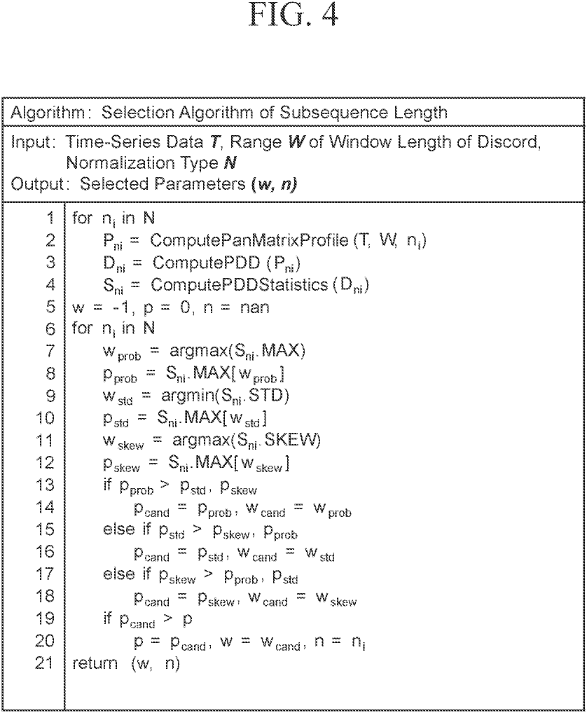

The parameter selecting unit 160 calculates a statistical feature of the probability density distribution PDD from the probability density distribution PDD for each m supplied from the probability density distribution calculating unit 140. Examples of the statistical feature include a maximum value, a standard deviation, a skewness, and a kurtosis. In addition, the parameter selecting unit 160 calculates or selects a set of an appropriate window length and a value of a type of a normalization method using the calculated statistical feature. Processing performed by the parameter selecting unit 160 will be described with reference to FIG. 4.

FIG. 4 is a diagram illustrating a sample code of an algorithm for selecting a set of the window length m and a normalization type n. and illustrates processing performed by the feature calculating unit 130 and the probability density distribution calculating unit 140 and processing performed by the parameter selecting unit 160. In the block of for sentence in the first to fourth lines in FIG. 4, the processing in the second to fourth lines are executed for each type of normalization. The second line is processing performed by the feature calculating unit 130, and the pan-matrix profile PMP is calculated from the time-series data. The third line is processing performed by the probability density distribution calculating unit 140, and the probability density distribution PDD is calculated from the pan-matrix profile PMP. In the fourth line, the parameter selecting unit 160 calculates a statistical feature of the probability density distribution PDD. The statistical feature includes the maximum value MAX of the probability density for each window length, the standard deviation STD of the PDD for each window length, and the skewness SKEW of the PDD for each window length.

In the fifth line, the window length w and the normalization type n, which are parameters output as the selection result, are initialized. Since the window length w does not become 0 or less, the window length w is initialized to -1, for example. The type of normalization n is initialized by any value nan that is not included in a set N of types of normalization. In addition, the variable p used in the algorithm is also initialized.

In the block of for sentence in the sixth to twentieth lines, the parameter selecting unit 160 executes processing in the seventh to twentieth lines for each type of normalization. In the seventh line and the eighth line, the parameter selecting unit 160 selects a window length w_{prob} in which the maximum value MAX of the probability density first becomes maximum, and stores the value of MAX at that time. In the ninth line and the tenth line, the parameter selecting unit 160 selects a window length w_{std} at which the standard deviation STD first becomes minimum, and stores the value of MAX at that time. In the eleventh line and the twelfth line, the parameter selecting unit 160 selects a window length w_{skew} at which the skewness SKEW first becomes maximum, and stores the value of MAX at that time. In the thirteenth line and the fourteenth line, when the maximum value p_{prob} of the probability density when MAX becomes maximum is larger than the maximum value p_{std} of STD and the maximum value p_{skew} of SKEW, the parameter selecting unit 160 stores the probability density p_{prob} at that time as p_{cand}, and sets the window length w_{prob} at that time as a result candidate w_{cand}. In the fifteenth to eighteenth lines, the parameter selecting unit 160 performs the same determination as that in the thirteenth line to fourteenth lines also for STD and SKEW. In the nineteenth to twentieth lines, when the probability density p_{cand} selected in the thirteenth to eighteenth lines is larger than the probability density p of the intermediate result of the selection result, the probability density p of the intermediate result is updated with p_{cand,} the window length w is updated with w_{cand}, and the type of normalization n is updated with nᵢ.

In the twenty-first line, the parameter selecting unit 160 outputs a set of the window length w and the normalization type n.

According to the above algorithm, in the case of the heat map of FIG. 3C, the window length w of the portion having a high appearance frequency in the circle A is output. Furthermore, the normalization type n in that case is output.

Although the algorithm that outputs the set of the window length w and the normalization type n when finding discord has been described above, in the case of finding motif, argmax in the eleventh line may be changed to argmin that obtains the minimum value. As a result, in the case of the heat map of FIG. 3C, the window length w of the portion having a high appearance frequency in the circle B is output Furthermore, the normalization type n in that case is output.

In the algorithm of FIG. 4, kurtosis may be used instead of or together with the standard deviation. By using kurtosis, it is possible to extract a steep peak, that is, a peak with maximum kurtosis.

The parameter selecting unit 160 supplies a set of the selected window length w and the normalization type n to the output unit 170.

### (Output Unit)

The output unit 170 outputs the heat map supplied from the heat map creating unit 150 and the selected parameter supplied from the parameter selecting unit 160 to an external device such as a display device.

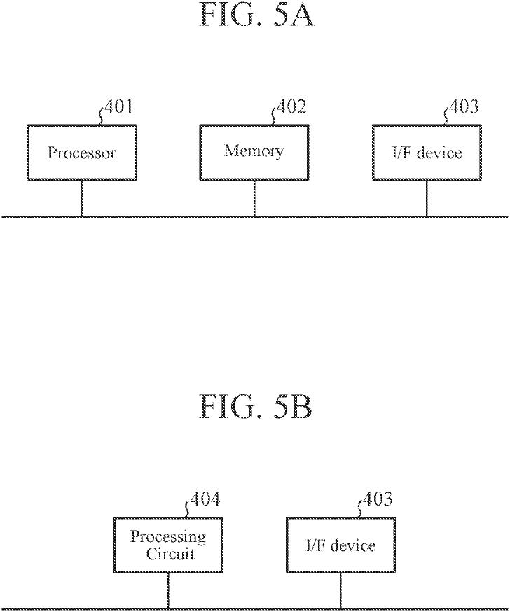

Next, a hardware configuration example of the time-series data analysis device 100 will be described with reference to FIGS. 5A and 5B. As an example, as illustrated in FIG. 5A, the time-series data analysis device 100 is implemented by a computer including a processor 401, a memory 402, and an I/F device 403. The I/F device 403 is a communication device that transmits and receives data to and from the outside, or an input/output port such as a USB port. The I/F device 403 implements the time-series data input unit 110, the parameter setting unit 120, and the output unit 170. In addition, the program stored in the memory 402 is read and executed by the processor 401, thereby implementing the parameter setting unit 120A, the feature calculating unit 130, the probability density distribution calculating unit 140, the heat map creating unit 150, and the parameter selecting unit 160. The program is implemented as software, firmware, or a combination of software and firmware. Examples of the memory 402 include a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, or a DVD.

As another example, as illustrated in FIG. 5B, the time-series data analysis device 100 includes a processing circuit 404 instead of the processor 401 and the memory 402. In this case, the processing circuit 404 implements the parameter setting unit 120A, the feature calculating unit 130, the probability density distribution calculating unit 140, the heat map creating unit 150, and the parameter selecting unit 160. The processing circuit 404 is, for example, a single circuit, a composite circuit, a programmed processor, a parallel programmed processor, an application specific integrated circuit (ASIC), a field-programmable gate array (FPGA), or a combination thereof. The functions of the feature calculating unit 130, the probability density distribution calculating unit 140, the heat map creating unit 150, and the parameter selecting unit 160 may be implemented by separate processing circuits, or these functions may be collectively implemented by one processing circuit.

### < Operation >

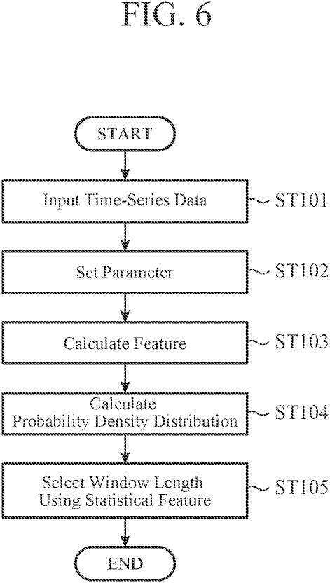

Next, the operation of the time-series data analysis device 100 will be described with reference to FIG. 6. In step ST101, the time-series data input unit 110 receives the time-series data. The time-series data input unit 110 outputs the received time-series data. In addition, in step ST102, the parameter setting unit 120 receives, as the value of the parameter, the upper limit value and the lower limit value of the length of the time series subsequence in the time-series data and the value that specifies the type of the normalization method of the time-series data, and sets the parameter. The parameter setting unit 120 outputs the set parameter value. The order of steps ST101 and ST102 is not limited.

The parameter setting unit 120A may calculate the upper limit value or the lower limit value of the length of the time series subsequence from the time-series data. Specifically, the parameter setting unit 120A may determine a range such as 10 (lower limit value) to 1/n (upper limit value) of the length of the time-series data. The character n is any positive integer. Alternatively, the parameter setting unit 120A may determine the range such as 1/n (lower limit value) of the length of the time-series data to 1000 (upper limit value). Alternatively, the parameter setting unit 120A may determine the range such as 1/10n (lower limit value) to 1/n (upper limit value) of the length of the time-series data In a case where the parameter setting unit 120A calculates the upper limit value or the lower limit value of the length of the time series subsequence from the time-series data, step ST102 is performed after step ST101.

In step ST103, the feature calculating unit 130 calculates the feature of the time-series data on the basis of the time-series data output by the time-series data input unit 110 and the parameter value output by the parameter setting unit 120 or the parameter setting unit 120A. For example, a matrix profile is calculated as the feature. The feature calculating unit 130 outputs the calculated feature.

In step ST104, the probability density distribution calculating unit 140 calculates the probability density distribution PDD of the feature of the time-series data output from the feature calculating unit 130. For example, the probability density distribution calculating unit 140 calculates the probability density distribution PDD for each of the plurality of matrix profiles supplied from the feature calculating unit 130. The probability density distribution calculating unit 140 outputs the calculated probability density distribution PDD.

In step ST105, the parameter selecting unit 160 calculates a statistical feature from the probability density distribution PDD calculated by the probability density distribution calculating unit 140, and selects a window length using the calculated statistical feature.

### < Storage Medium of Program >

The above-described program may be stored in a storage medium. Examples of the storage medium include a nonvolatile or volatile semiconductor memory such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, or a DVD.

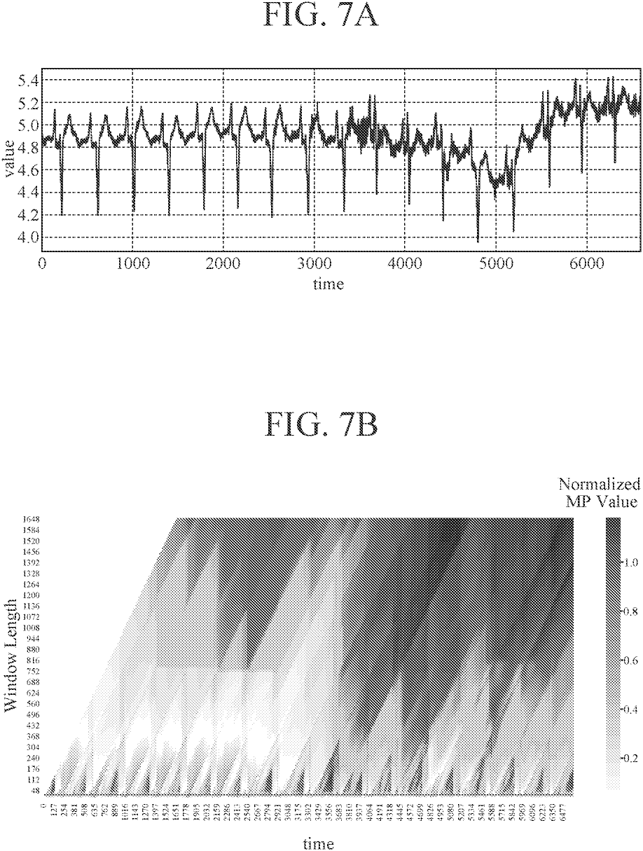

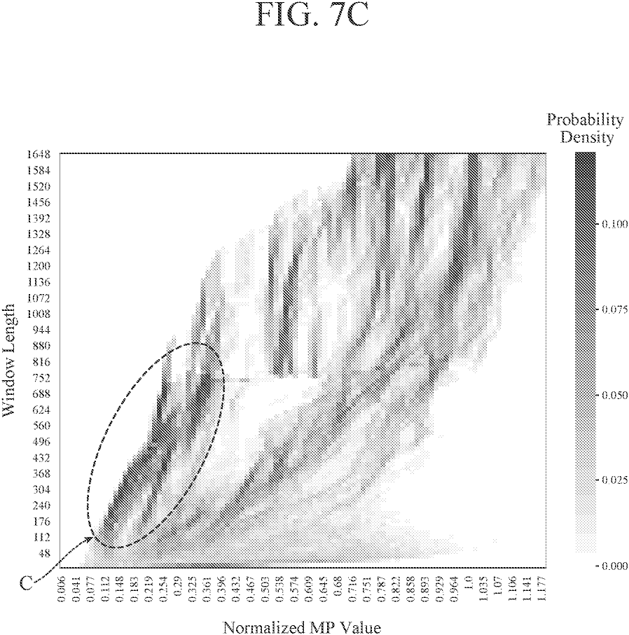

Although the configuration and operation of the time-series data analysis device 100 have been described above while referring to a case where the time-series data includes an abnormal or similar time series subsequence, the time-series data analysis device 100 is useful for analysis of any time-series data. For example, even in a case where no anomaly data is included, the time-series data analysis device 100 according to the present disclosure is useful. This will be described with reference to FIGS. 7A to 7C, FIG. 7A is time-series data of the same type as that of FIG. 3A. The time-series data of FIG. 3A includes a plurality of pieces of anomaly data, but the time-series data of FIG. 7A does not include anomaly data. FIG. 7B is a pan-matrix profile PMP created from the time-series data of FIG. 7A. FIG. 7C is a heat map of the probability density distribution created from the pan-matrix profile PMP of FIG. 7B.

Since the time-series data of FIG. 7A does not include anomaly data, the value of the matrix profile generated from the time-series data of FIG. 7A does not include a large value. For example, when looking at the matrix profile value in the case of the window length 205 in FIG. 3B, it can be confirmed that the matrix profile value is large at the times corresponding to the three anomaly points ANO1 to ANO3 in FIG. 3A. On the other hand, in the matrix profile value in the case of the window length 205 in FIG. 7B, since the time-series data in FIG. 7A does not include anomaly data, there is no large value as in the case of FIG. 3B. Therefore, the probability density distribution created for the case of the window length 205 in FIG. 7B has a distribution in which the skirt (portion having a large matrix profile value) on the right side of the probability density distribution is shorter than the probability density distribution created for the case of the window length 205 in FIG. 3B.

Even in the case where the right skirt of the probability density distribution becomes short as described above, the influence of removal of the anomaly data is equally reflected in the distribution of the normal data. Therefore, when probability density distributions of different window lengths are compared, relative features between the probability density distributions are not different. For example, the window length at which the probability density becomes maximum in the probability density distribution of the matrix profile created from the time-series data including the anomaly data is the same as the window length at which the probability density becomes maximum in the probability density distribution of the matrix profile created from the time-series data obtained by removing the anomaly data from the time-series data. In addition, the window length at which the standard deviation becomes minimum in the probability density distribution of the matrix profile created from the time-series data including the anomaly data is the same as the window length at which the standard deviation becomes minimum in the probability density distribution of the matrix profile created from the time-series data obtained by removing the anomaly data from the time-series data. In addition, the window length at which the skewness becomes maximum in the probability density distribution of the matrix profile created from the time-series data including the anomaly data is the same as the window length at which the skewness becomes maximum in the probability density distribution of the matrix profile created from the time-series data obtained by removing the anomaly data from the time-series data. In addition, the window length at which kurtosis becomes maximum in the probability density distribution of the matrix profile created from the time-series data including the anomaly data is the same as the window length at which kurtosis becomes maximum in the probability density distribution of the matrix profile created from the time-series data obtained by removing the anomaly data from the time-series data.

Therefore, as indicated by a circle C in FIG. 7C, a region corresponding to the region indicated by the circle A in FIG. 3C appears. An appropriate window length can be obtained by searching for the peak of the appearance frequency in the circle C or calculating the average value of the maximum value and the minimum value of the window length in the region of the circle C.

Therefore, even in a case where anomaly data has not yet been obtained from a certain device to be analyzed, the time-series data analysis device 100 according to the present disclosure can find a window length appropriate for analysis of the time-series data of the device to be analyzed. By monitoring the value of the matrix profile of the device to be analyzed using the found window length, it is possible to determine that an anomaly has occurred when a large matrix profile value is found.

### Second Embodiment

### < Configuration >

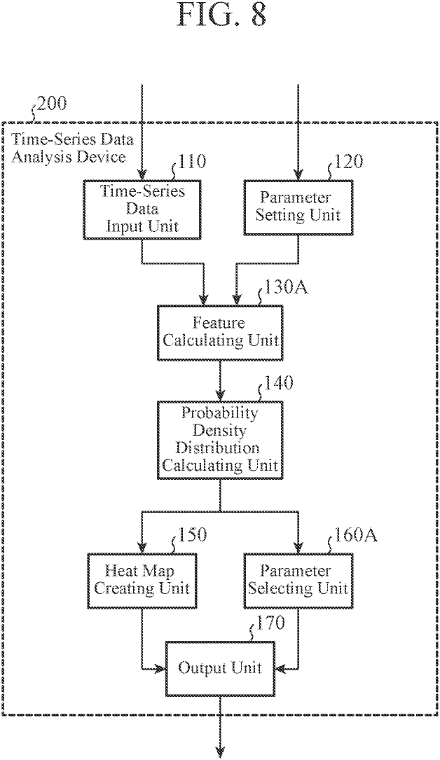

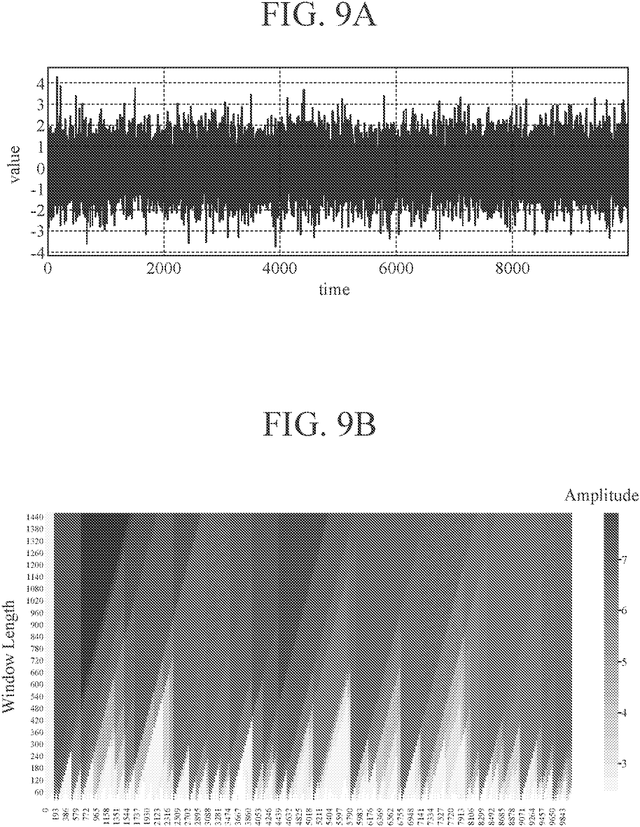

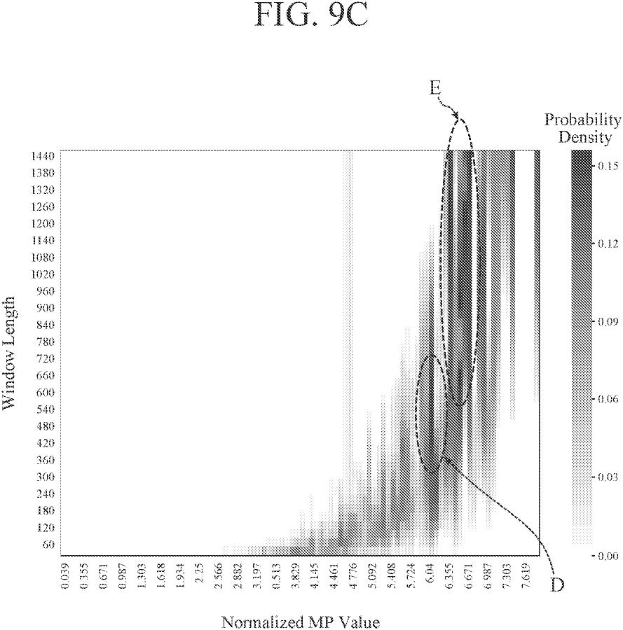

In the first embodiment, the case where the feature calculated by the feature calculating unit 130 is the matrix profile has been described. In a second embodiment, a case where such feature is double amplitude (Peak-to-Peak) will be described with reference to FIGS. 8 and 9A to 9C. In the second embodiment, time-series data as illustrated in FIG. 9A is assumed as time-series data to be input. There is a demand in the industry for grasping main amplitudes in oscillatory time-series data. On the other hand, since the amplitude varies depending on the window length, it is necessary to select an appropriate window length. In the second embodiment, a time-series data analysis device that meets such a requirement or necessity will be described. Note that in the description of the second embodiment, only portions different from those of the first embodiment will be described, and redundant description will be omitted.

As illustrated in FIG. 8, a time-series data analysis device 200 according to the second embodiment includes a time-series data input unit 110, a parameter setting unit 120, a probability density distribution calculating unit 140, a heat map creating unit 150. and an output unit 170 as in the case of the first embodiment. Further, unlike the first embodiment, the time-series data analysis device 200 includes a feature calculating unit 130A and a parameter selecting unit 160A.

The feature calculating unit 130A calculates the feature of the time-series data on the basis of the time-series data supplied from the time-series data input unit 110 and the parameter value supplied from the parameter setting unit 120. A double amplitude (Peak-to-Peak) is calculated as the feature. The feature calculating unit 130A changes the value of the length m of the time series subsequence within the range of the upper limit value and the lower limit value of the length of the time series subsequence set via the parameter setting unit 120, and calculates a double amplitude for each of various types of m. The feature calculating unit 130A calculates a double amplitude for each window length as illustrated in FIG. 9B from the time-series data as illustrated in FIG. 9A. The feature calculating unit 130A supplies the generated double amplitudes to the probability density distribution calculating unit 140 as features of the time-series data.

As in the case of the first embodiment, the probability density distribution calculating unit 140 calculates a probability density distribution PDD for each m from the features supplied from the feature calculating unit 130A. The calculated probability density distribution PDD is supplied to the heat map creating unit 150 and the parameter selecting unit 160A.

The heat map creating unit 150 creates a heat map from the probability density distribution PDD for each m supplied from the probability density distribution calculating unit 140. FIG. 9C illustrates a heat map of the calculated probability density distribution PDD. In a region indicated by a circle D, when the window length is 400 to 700, it is shown that there are many vibrating elements having double amplitudes of about 6.0. In a region indicated by a circle E. when the window length is 600 or more, it is shown that there are many vibrating elements having double amplitudes of about 6.7. The heat map creating unit 150 outputs the created heat map to the output unit 170.

The parameter selecting unit 160A calculates a statistical feature of the probability density distribution PDD according to the algorithm illustrated in FIG. 3, and selects a window length corresponding to a portion where the probability density is high using the calculated statistical feature. The parameter selecting unit 160A supplies the selected parameter to the output unit 170.

The output unit 170 outputs the heat map supplied from the heat map creating unit 150 and the selected parameter supplied from the parameter selecting unit 160A to an external device such as a display device.

### < Supplement >

Some of various aspects of the embodiments described above will be summarized below.

### (Supplement 1)

A time-series data analysis device (100, 100A; 200) of Supplement 1 includes: a time-series data input unit (110) to receive time-series data; a parameter setting unit (120, 120A) to set a range of a window length of a time series subsequence in the time-series data: a feature calculating unit (130; 130A) to calculate a feature of the time-series data for each of a plurality of window lengths within the range; a probability density distribution calculating unit (140) to calculate a probability density distribution of the calculated feature for each of the plurality of window lengths; and a parameter selecting unit (160; 160A) to calculate a statistical feature of the probability density distribution calculated for each of the plurality of window lengths and select a window length to be used from among the plurality of window lengths on the basis of the calculated statistical feature.

### (Supplement 2)

A time-series data analysis device (100, 100A; 200) of Supplement 2 is the time-series data analysis device according to Supplement 1. in which the feature is a value of a matrix profile or a double amplitude value.

### (Supplement 3)

A time-series data analysis device (100, 100A; 200) of Supplement 3 is the time-series data analysis device of Supplement 1 or 2. in which the parameter setting unit (120A) sets the range by calculating at least one of an upper limit value and a lower limit value on the basis of the received time-series data.

### (Supplement 4)

A time-series data analysis device (100, 100A; 200) of Supplement 4 is the time-series data analysis device of any one of Supplements 1 to 3, in which the statistical feature is a maximum value, and the parameter selecting unit selects a window length having a maximum probability density as the window length to be used.

### (Supplement 5)

A time-series data analysis device (100. 100A; 200) of Supplementary note 5 is the time-series data analysis device of any one of Supplements 1 to 4, in which the statistical feature is a standard deviation, and the parameter selecting unit selects a window length having a minimum standard deviation as the window length to be used.

### (Supplement 6)

A time-series data analysis device (100, 100A; 200) of Supplement 6 is the time-series data analysis device of any one of Supplements 1 to 5, in which the statistical feature is a skewness, and the parameter selecting unit selects a window length having a positive or negative skewness as the window length to be used.

### (Supplement 7)

A time-series data analysis device (100, 100A: 200) of Supplement 7 is the time-series data analysis device of any one of Supplements 1 to 6, in which the statistical feature is a kurtosis, and the parameter selecting unit selects a window length having a maximum kurtosis as the window length to be used.

### (Supplement 8)

A time-series data analysis device (100, 100A; 200) of Supplement 8 is the time-series data analysis device of any one of Supplements 1 to 7, and further includes a heat map creating unit (150) to create a heat map of the calculated probability density distribution from the calculated probability density distribution.

### (Supplement 9)

A time-series data analysis method of Supplement 9 includes the steps of: receiving, by a time-series data input unit (110), time-series data (ST101 ); setting, by a parameter setting unit (120), a range of a window length of a time series subsequence in the time-series data (ST102); calculating, by a feature calculating unit (130), a feature of the time-series data for each of a plurality of window lengths within the range (ST103): calculating, by a probability density distribution calculating unit (140), a probability density distribution of the calculated feature for each of the plurality of window lengths (ST104); and calculating, by a parameter selecting unit (160), a statistical feature of the probability density distribution calculated for each of the plurality of window lengths and selecting a window length to be used from among the plurality of window lengths on a basis of the calculated statistical feature (ST105).

### (Supplement 10)

A time-series data analysis program of Supplement 10 causes a computer to execute: a time-series data input function of receiving time-series data; a parameter setting function of setting a range of a window length of a time series subsequence in the time-series data; a feature calculating function of calculating a feature of the time-series data for each of a plurality of window lengths within the range; a probability density distribution calculating function of calculating a probability density distribution of the calculated feature for each of the plurality of window lengths; and a parameter selecting function of calculating a statistical feature of the probability density distribution calculated for each of the plurality of window lengths and selecting a window length to be used from among the plurality of window lengths on a basis of the calculated statistical feature.

Note that the embodiments can be combined, and the embodiments can be appropriately modified or omitted.

### INDUSTRIAL APPLICABILITY

Since the time-series data analysis device according to the present disclosure includes the parameter selecting unit, it is possible to propose a window length used when analyzing the time-series data. Thus, that time-series data analysis device can be used to analyze time-series data with an unknown suitable window length.

### REFERENCE SIGNS LIST

100: time-series data analysis device, 100A: time-series data analysis device, 110: time-series data input unit. 120: parameter setting unit, 120A: parameter setting unit, 130: feature calculating unit, 130A: feature calculating unit, 140: probability density distribution calculating unit, 150: heat map creating unit, 160: parameter selecting unit, 160A: parameter selecting unit, 170: output unit, 200: time-series data analysis device, 401: processor, 402: memory, 403: I/F device. 404: processing circuit

1. A time-series data analysis device, comprising:
processing circuitry
to receive time-series data;
to set a range of a window length of a time series subsequence in the time-series data;
to calculate a feature of the time-series data for each of a plurality of window lengths within the range;
to calculate a probability density distribution of the calculated feature for each of the plurality of window lengths; and
to calculate a statistical feature of the probability density distribution calculated for each of the plurality of window lengths and select a window length to be used from among the plurality of window lengths on a basis of the calculated statistical feature.

2. The time-series data analysis device according to claim 1, wherein the feature is a value of a matrix profile or a double amplitude value.

3. The time-series data analysis device according to claim 1, wherein the processing circuitry sets the range by calculating at least one of an upper limit value and a lower limit value on a basis of the received time-series data.

4. The time-series data analysis device according to claim 1, wherein the statistical feature is a maximum value, and the processing circuitry selects a window length having a maximum probability density as the window length to be used.

5. The time-series data analysis device according to claim 1, wherein the statistical feature is a standard deviation, and the processing circuitry selects a window length having a minimum standard deviation as the window length to be used.

6. The time-series data analysis device according to claim 1, wherein the statistical feature is a skewness, and the processing circuitry selects a window length having a positive or negative skewness as the window length to be used.

7. The time-series data analysis device according to claim 1, wherein the statistical feature is a kurtosis, and the processing circuitry selects a window length having a maximum kurtosis as the window length to be used.

8. The time-series data analysis device according to claim 1, the processing circuitry is further configured to create a heat map of the calculated probability density distribution from the calculated probability density distribution.

9. The time-series data analysis device according to claim 2, the processing circuitry is further configured to create a heat map of the calculated probability density distribution from the calculated probability density distribution.

10. The time-series data analysis device according to claim 3, the processing circuitry is further configured to create a heat map of the calculated probability density distribution from the calculated probability density distribution.

11. The time-series data analysis device according to claim 4, the processing circuitry is further configured to create a heat map of the calculated probability density distribution from the calculated probability density distribution.

12. The time-series data analysis device according to claim 5, the processing circuitry is further configured to create a heat map of the calculated probability density distribution from the calculated probability density distribution.

13. The time-series data analysis device according to claim 6, the processing circuitry is further configured to create a heat map of the calculated probability density distribution from the calculated probability density distribution.

14. The time-series data analysis device according to claim 7, the processing circuitry is further configured to create a heat map of the calculated probability density distribution from the calculated probability density distribution.

15. A time-series data analysis method, comprising:
receiving time-series data;
setting a range of a window length of a time series subsequence in the time-series data;
calculating a feature of the time-series data for each of a plurality of window lengths within the range;
calculating a probability density distribution of the calculated feature for each of the plurality of window lengths; and
calculating a statistical feature of the probability density distribution calculated for each of the plurality of window lengths and selecting a window length to be used from among the plurality of window lengths on a basis of the calculated statistical feature.

16. A non-transitory computer readable medium storing time-series data analysis program for causing a computer to execute;
a time-series data input function of receiving time-series data;
a parameter setting function of setting a range of a window length of a time series subsequence in the time-series data;
a feature calculating function of calculating a feature of the time-series data for each of a plurality of window lengths within the range;
a probability density distribution calculating function of calculating a probability density distribution of the calculated feature for each of the plurality of window lengths; and
a parameter selecting function of calculating a statistical feature of the probability density distribution calculated for each of the plurality of window lengths and selecting a window length to be used from among the plurality of window lengths on a basis of the calculated statistical feature.
